(19) United States
(12) Patent Application Publication
(10) Pub. No.: US 2005/0211883 A1
(43) Pub. Date: Sep. 29, 2005

(54) Light grid

(75) Inventor: Lutz Lohmann, Olching (DE)

Correspondence Address: VENABLE LLP, P.O. BOX 34385, WASHINGTON, DC, 20045-9998, US

(73) Assignee: Leuze Lumiflex GmbH & Co., KG, Furstenfeldbruck (DE)

(21) Appl. No.: 11/131,198

(22) Filed: May 18, 2005

Related U.S. Application Data
(63) Continuation of application No. 10/975,187, filed on Oct. 28, 2004.

(30) Foreign Application Priority Data
Oct. 31, 2003 (DE) 103 50 927.5

(51) Int. Cl. G06M 7/00

(52) U.S. Cl. 250/221

(57) ABSTRACT

A light grid for detecting objects in an area to be monitored comprises a transmitting unit including a number of transmitters that emit light rays and a receiving unit including a number of receivers. Each transmitter is assigned one receiver to form a beam path with the assigned receiver. The light rays emitted by each transmitter are guided onto a respective one of the receivers when there is a clear beam path and causing the respective receiver to produce an output signal representing the light rays guided onto that receiver. An evaluation unit comprising a digital signal processor has an input coupled to the receivers to evaluate the receiver output signals and to generate an object detection signal if at least one beam path is interrupted through an object intervention in the area to be monitored.

### CROSS-REFERENCE TO RELATED APPLICATIONS

This application is a continuation of application Ser. No. 10/975,187, filed Oct. 28, 2004 and claiming the priority of German Patent Application No. 103 50 927.5-52, filed on Oct. 31, 2003, which priority is also claimed in the present application. The disclosures of the foregoing applications and each U.S. and foreign patent and patent application mentioned herein are incorporated by reference into this application.

### BACKGROUND OF THE INVENTION

The invention relates to a light grid for detecting objects in an area to be monitored, in which the light grid comprises a transmitting unit with a number of transmitters that emit light rays and a receiving unit having a number of receivers. Each transmitter is assigned one receiver for forming a beam path, such that with a clear beam path, the light rays emitted by the respective transmitter are guided onto the associated receiver. An evaluation unit evaluates the signals present at the outputs of the receivers and an object detection signal is generated in the evaluation unit if at least one beam path is interrupted by object intervention in the area to be monitored.

A light grid of this type disclosed, for example in German Patent DE 39 39 191 C2, is provided with a two-channel evaluation unit, having a microcontroller in each evaluation channel. An object detection signal is generated in the microcontrollers from the receiver signals. Each microcontroller is assigned a separate analog circuit in the evaluation channels, wherein these circuits function to amplify as well as to pre-process the receiver signals.

The analog circuit in one evaluation channel in particular comprises a two-channel amplifier with two downstream installed comparators which are set to different switching thresholds. The output signals from the comparators are assigned to a monostable flip-flop. The signal pulses present at the flip-flop are fed to a counter. The receiving signals are pre-processed with this circuit to detect contamination of the transmitters or receivers.

The disadvantage of such analog circuits is that they are sensitive to external interfering influences, for example EMC (electromagnetic compatibility) interfering influences and thermal drifts of the individual components.

Interfering influences of this type lead to distorted and falsified receiver signals and, in the final analysis, also to incorrect object detections which result in an undesirable reduction in the detection sensitivity of the light grid.

### SUMMARY OF THE INVENTION

It is an object of the present invention to provide a light grid of the aforementioned type which simultaneously combines the simplest possible design with a high detection sensitivity and robustness against external interfering influences.

The above and other objects are accomplished according to the invention by the provision of a light grid for detecting objects in an area to be monitored, comprising: a transmitting unit including a number of transmitters that emit light rays; a receiving unit including a number of receivers, each transmitter being assigned one receiver to form a beam path with the assigned receiver, the light rays emitted by each transmitter being guided onto a respective one of the receivers when there is a clear beam path and causing the respective receiver to produce an output signal representing the light rays guided onto that receiver; and an evaluation unit comprising a digital signal processor having an input coupled to the receivers to evaluate the receiver output signals and to generate an object detection signal if at least one beam path is interrupted through an object intervention in the area to be monitored.

The invention is essentially based on the idea that by using at least one digital signal processor as the evaluation unit, an analog circuit for pre-processing the receiving signals can be omitted. Thus, only components for the impedance conversion, installed downstream of the receivers, are typically required as analog circuit components for adapting the signal levels of the receiving signals, such that they can be read into the digital signal processor.

The receiver output signals which are generated and, if necessary, pre-amplified in the receivers may be digitized directly in the digital signal processor, wherein at least one analog-digital converter is preferably provided for this purpose.

Since the evaluation unit is nearly devoid of analog circuit components, it is insensitive to external interfering influences, such as electromagnetic compatibility (EMC) irradiation or thermal drifts of individual circuit components.

Advantageous software routines may be integrated into the digital signal processor for realizing the signal pre-processing of the digitized receiver output signals. The software routines may be configured as digital search filters, for example, which are used to separate the useful signals from the background signals in the digitized receiver output signals. The software routines in general are used to separate background signals, caused by interfering influences such as noise and extraneous light irradiation, from the useful signals, thereby considerably increasing the detection sensitivity of the light grid.

In the most basic form, the evaluation unit for the light grid according to the invention has a single-channel layout with a digital signal processor.

When using the light grid in the area of safety engineering, in particular relating to the safety of persons, the evaluation unit is provided with means for monitoring the digital signal processor, wherein these monitoring means can be embodied differently, depending on the required safety category of the light grid.

For a light grid corresponding to a type 2 safety category, as defined for European Standard EN 954, the evaluation unit is provided with a digital signal processor. The operation of this digital signal processor is monitored by means of a monitoring channel, for example provided with a microprocessor.

For a light grid corresponding to a type 4 safety category, as defined for European Standard EN 954, the evaluation unit has a two-channel layout with two digital processors that monitor each other.

### BRIEF DESCRIPTION OF THE DRAWINGS

The invention is explained in the following with the aid of drawings, which show in:

FIG. 1: A schematic representation of a first exemplary embodiment of a light grid for detecting objects in an area to be monitored according to the invention.

FIG. 2: A schematic representation of an evaluation unit embodied as digital signal processor for the light grid shown in FIG. 1.

FIG. 3: A schematic representation of an evaluation unit embodied as digital signal processor with an associated monitoring channel for the light grid as shown in FIG. 1.

FIG. 4: A schematic representation of an evaluation unit with two digital signal processors for the light grid as shown in FIG. 1.

### DETAILED DESCRIPTION OF THE INVENTION

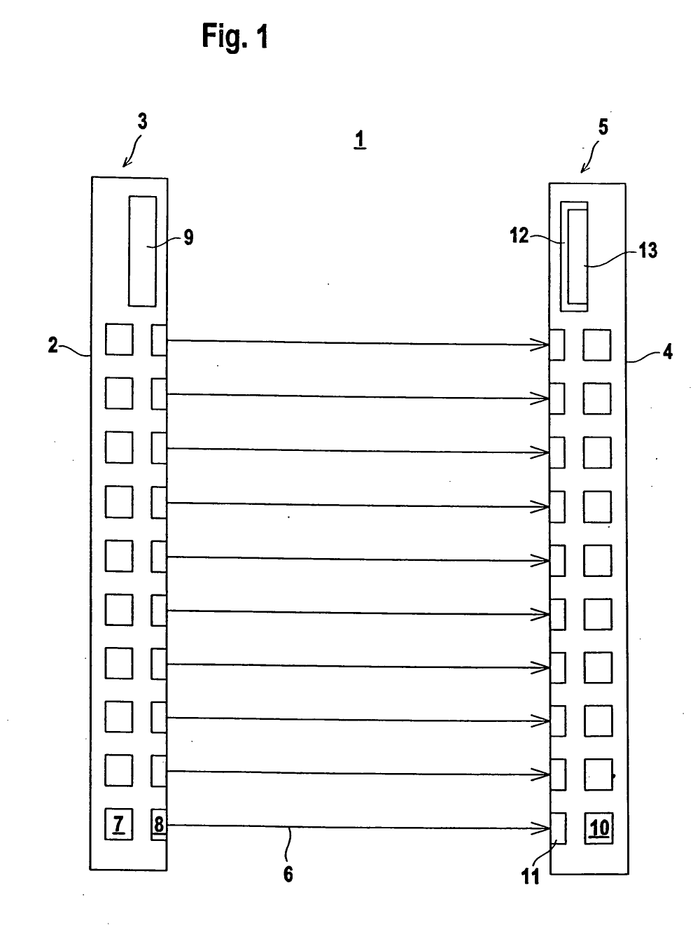

FIG. 1 shows a layout of a light grid 1 for monitoring an area to be monitored. Light grid 1 comprises a transmitting unit 3, integrated into a first housing 2, and a receiving unit 5 that is integrated into a second housing 4. Transmitting unit 3 and receiving unit 5 are positioned on opposite edges of the area to be monitored.

Transmitting unit 3 consists of an arrangement of transmitters 7 for emitting light rays 6. Transmitters 7 preferably are identical light-emitting diodes, disposed at a distance next to each other, wherein transmitters 7 are preferably arranged equidistant along a straight line. For the beam formation with transmitting light rays 6, a transmitting optic 8 is installed upstream of each transmitter 7. Each respective transmitting optic 8 is installed behind an exit window, not shown separately herein, in a front wall region of housing 2. Transmitters 7 for this embodiment emit transmitting light rays 6 in the infrared range. However, transmitters 7 in principle can also emit transmitting light rays 6 in the visible wavelength range.

The optical axes of the transmitting light rays 6 guided inside the area to be monitored extend parallel to each other in the plane for the area to be monitored.

Transmitters 7 are triggered by a transmitter control unit 9, wherein transmitters 7 for the present embodiment are operated in a pulsed mode. Transmitters 7 thus emit transmitting light pulses with a predetermined pulse-interval ratio. Individual transmitters 7 cyclically emit successive transmitting light pulses, wherein these pulses are clocked by means of transmitter control unit 9. In the process, transmitters 7 are activated successively within one scanning cycle, according to their sequence in the transmitting unit 3 and in a predetermined scanning direction. The transmitting light pulses from first transmitter 7 function to synchronize light grid 1. For this, the transmitting light pulses from a first transmitter 7 are advantageously provided with a coding which clearly differs from the coding assigned to the transmitting light pulses coming from the remaining transmitters 7.

The receiving unit 5 comprises an arrangement of identical side-by-side arranged receivers 10. Receivers 10 preferably are individual photodiodes, arranged equidistant along a straight line, with a separate receiving optic 11 installed upstream of each receiver 10. Respectively one transmitter 7 of transmitting unit 3 is positioned opposite one receiver 10 in this case. For the present embodiment, the beam formed with transmitting light rays 6 is formed such that the transmitting light rays 6 of each separate transmitter 7 only impinge on an oppositely arranged transmitter 10 if the beam path is clear, wherein each transmitter 7 and associated receiver 10 jointly form one beam path of the light grid 1.

Receivers 10 are controlled by means of a receiver control unit 12. The signals received and present at the outputs of the receivers 10 are evaluated in an evaluation unit 13 which forms a component of receiver control unit 12. If the beam paths for light grid 1 are clear, the transmitting light rays 6 arrive without interference at the associated receivers 10 where they generate a reference receiver output signal that corresponds to a clear beam path. In particular, a threshold value is used to evaluate the receiver output signals in evaluation unit 13, wherein the amplitudes for the reference receiver output signals are above the threshold value.

The beam path for the transmitting light rays 6 from at least one transmitter 7 is interrupted if an object enters the area to be monitored. The receiving signal for the associated receiver 10 in that case is below the threshold value, meaning no reference receiving signals are recorded at this receiver 10.

Interruptions of the beam paths are evaluated in the evaluation unit 13 for generating an object detection signal. The object detection signal is a binary switching signal with the switching states “0” and “1.” The switching state “0” corresponds to a clear beam path of light grid 1, meaning no object was recorded in the area to be monitored. The switching state “1” corresponds to an object intervention in the one of the beam paths for light grid 1. The interruption of a single beam path is preferably sufficient to indicate an object intervention. If light grid 1 is used in an area of safety engineering, the generating of an object-detection signal of this type will trigger the generating of a command for shutting down a machine or plant for which the surrounding area is monitored with a light grid 1.

Light grid 1 in that case forms a personal protection device which prevents persons from entering an area surrounding a machine while the machine is in operation.

The term light grid 1 generally refers to multiple arrangements of light barriers and light curtains.

In principle, light grid 1 can also be embodied as a transceiver in which case the transmitters 7 of the transmitting unit 3 and the receivers 10 of the receiver unit 5 are housed inside a joint housing, arranged at one edge of the area to be monitored. In that case, a reflector is disposed at the opposite edge of the area to be monitored. With a clear beam path for light grid 1, light rays 6 emitted by transmitters 7 will be reflected back via the reflector to the associated receivers 10.

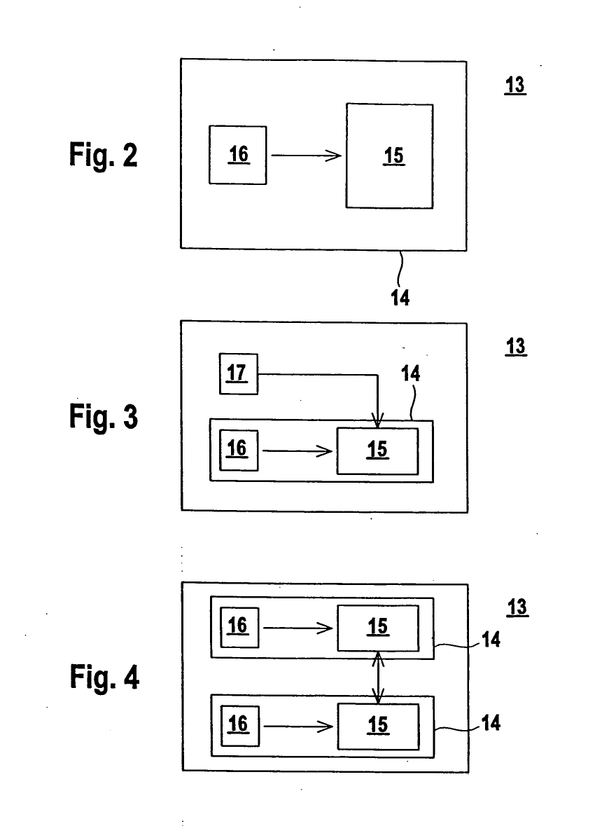

FIG. 2 shows an embodiment of an evaluation unit 13 for a light grid 1 which is used for non safety-critical applications. The evaluation unit 13 consequently has a single-channel layout.

Evaluation unit 13 according to FIG. 2 consists of a digital signal processor 14. The digital signal processor 14 is provided with an analog-digital converter 16, arranged upstream of the actual processor unit 15. The analog-digital converter 16 for the present case is an 8-bit analog-digital converter 16, meaning analog-digital converter 16 has a word width of n=8 bits. In general, other bit widths can also be used, depending on the resolution of the analog-digital converter 16. Analog digital converter 16 is used to digitize the receiver output signals.

On the receiving side, individual receivers 10 are followed by only analog circuit elements for impedance conversion of the receiver output signal levels, so that these levels can be adapted to match the required input signal level for the analog-digital converter 16.

Receiver control unit 12 is provided with a timing unit, not shown herein, for activating the individual receivers 10, such that they are synchronized with the respectively associated transmitters 7. As a result, the receivers 10 are activated cyclically and successive, in the same way as the transmitters 7. The receiving signals, which are generated successively in the receivers 10 with the timing predetermined by the receiver control unit 12, are read into digital signal processor 14 of evaluation unit 13. In analog-digital converter 16, the analog receiver output signals of receivers 10 are serially digitized. The digital signals generated in this way are evaluated in processor unit 15 of digital signal processor 14. An application-specific integrated circuit (ASIC) is used for the timing control, for example, which is a digitally operating component in the same way as the digital signal processor 14.

The digital signals are initially pre-processed in digital signal processor 14 by means of suitable software routines that are implemented in digital signal processor 14. In particular, a digital search filter can be used for a software routine of this type. The signal processing operation, realized with these software routines, permits the separation of the useful signal components in the digitized receiver output signals, generated when transmitted light rays 6 impinge on the individual receivers 10, from the background signals caused by interfering influences such as noise and extraneous light irradiation.

The digital signals pre-processed in this way are subsequently evaluated with the threshold value for generating the object detection signal. The threshold value unit provided for this is integrated into processor unit 15 of digital signal processor 14.

FIG. 3 shows a second exemplary embodiment of an evaluation unit 13 for light grid 1 shown in FIG. 1. Light grid 1 with evaluation unit 13, shown in FIG. 3, can be used for type 2 safety-engineering categories, as defined for European Standard EN 954. The evaluation unit 13, shown in FIG. 3, also comprises a digital signal processor 14 with an analog-digital converter 16 and a processor unit 15, wherein this digital signal processor 14 is embodied and functions in the same way as the embodiment shown in FIG. 2.

To meet the requirements of the type 2 safety category, evaluation unit 13 is provided with a monitoring channel which in the present case is essentially a microprocessor 17. While digital signal processor 14 is used for processing the receiver output signals and for generating the object detection signal, the sole function of the microprocessor 17 in the monitoring channel is to monitor the operation of digital signal processor 14. The microprocessor 17 in particular functions to monitor the results generated by digital signal processor 14, wherein microprocessor 17 also monitors the transit times for digital signal processor 14. If microprocessor 17 uncovers a malfunction in digital signal processor 14, the digital signal processor is shut down by means of microprocessor 17.

FIG. 4 shows a different exemplary embodiment of an evaluation unit 13 for light grid 1 shown in FIG. 1. Light grid 1 with evaluation unit 13, shown in FIG. 4, is designed for type 4 safety-engineering applications, as defined for European Standards EN 954. Evaluation unit 13 is provided with two channels for this, comprising two digital signal processors 14 that monitor each other. The digital signal processors 14 are identical and the layout corresponds to that of digital signal processor 14 shown in FIG. 4. The receiving signals are read into both digital signal processors 14 by means of analog-digital converters 16 integrated therein. Both digital signal processors 14 perform a signal pre-processing of the digitized receiving signals, followed by a subsequent evaluation of the pre-processed digital signals for generating the object detection signal. A valid object detection signal is generated only if an identical signal is computed in both digital signal processors 14 from the receiver output signals. In case of a malfunction in at least one digital signal processor 14 or a deviation in the signal evaluation in the two digital signal processors 14, a shutdown command is issued for both digital signal processors 14, causing the complete system to change to the safe state. No object detection signal is therefore generated in case of a malfunction in evaluation unit 13 by means of which a machine or plant monitored by a light grid 1 would be activated.

The invention has been described in detail with respect to exemplary embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. A light grid for detecting objects in an area to be monitored, comprising:
a transmitting unit including a number of transmitters that emit light rays;
a receiving unit including a number of receivers, each transmitter being assigned one receiver to form a beam path with the assigned receiver, the light rays emitted by each transmitter being guided onto a respective one of the receivers when there is a clear beam path and causing the respective receiver to produce an output signal representing the light rays guided onto that receiver; and
an evaluation unit comprising a digital signal processor having an input coupled to the receivers to evaluate the receiver output signals and to generate an object detection signal if at least one beam path is interrupted through an object intervention in the area to be monitored.

2. The light grid according to claim 1, wherein the output signals of the receivers are analog signals and further including at least one analog-digital converter arranged to convert the analog output signals of the receivers to digital signals that are evaluated by the digital signal processor.

3. The light grid according to claim 2, wherein the at least one analog-digital converter is internal to the digital signal processor.

4. The light grid according to claim 2, wherein the at least one analog-digital converter is external to the digital signal processor.

3. The light grid according to claim 2, wherein the analog-digital converter comprises an n-bit analog-digital converter where n>1.

4. The light grid according to claim 3, further including software routines for signal preprocessing implemented in the digital processor.

5. The light grid according to claim 4, wherein the software routines include digital search filters implemented in the digital signal processor to separate useful signals in the digital signals from background signals.

6. The light grid according to claim 1, wherein the evaluation unit has a single-channel layout.

7. The light grid according to claim 6, wherein the evaluation unit comprises a channel for monitoring the operation of the digital signal processor.

8. The light grid according to claim 7, wherein the monitoring channel includes a microprocessor.

9. The light grid according to claim 8, wherein results of signal evaluation in the digital signal processor are monitored by means of the microprocessor.

10. The light grid according to claim 1, wherein the evaluation unit comprises a two-channel layout including two digital signal processors that monitor each other.
